(19) United States
(12) Patent Application Publication
(10) Pub. No.: US 2025/0375066 A1
(43) Pub. Date: Dec. 11, 2025

(54) SHOWER ENCLOSURE ASSEMBLY WITH CLEANING MECHANISM

(71) Applicant: Kohler India Corporation Pvt Ltd., New Delhi (IN)

(72) Inventors: Jayesh BODKHEY, New Delhi (IN); Amit SHINGATE, New Delhi (IN); Rohan MORE, New Delhi (IN); Parul GUPTA, New Delhi (IN); Anshuman GUPTA, New Delhi (IN)

(73) Assignee: Kohler India Corporation Pvt Ltd., New Delhi (IN)

(21) Appl. No.: 19/221,250

(22) Filed: May 28, 2025

(30) Foreign Application Priority Data
Jun. 6, 2024 (IN) 202411044121

(51) Int. Cl. A47K 3/28; B08B 1/14; B08B 1/34

(52) U.S. Cl. CPC A47K 3/281; B08B 1/143; B08B 1/145; B08B 1/34

(57) ABSTRACT

The present disclosure is generally directed towards a cleaning mechanism for a shower assembly. The cleaning mechanism includes a cleaning assembly and a pulley system. The cleaning assembly includes a rack coupled to an inner shower surface, a roller comprising a gear configured to traverse along the rack, a cable configured to drive the gear from a first end of the rack towards a second end of the rack, and an apparatus configured to wipe the inner shower surface, wherein an end of the apparatus is coupled to the roller.

### CROSS-REFERENCE TO RELATED PATENT APPLICATIONS

This application claims priority to and the benefit of Indian Patent Application number 202411044121, filed Jun. 6, 2024, incorporated herein by reference in its entirety.

### BACKGROUND

The present disclosure relates generally to a water delivery devices, such as showers. More specifically, the present disclosure relates to a cleaning mechanism of a shower enclosure assembly.

### SUMMARY

At least one aspect of the present disclosure relates to a cleaning mechanism for a shower assembly. The cleaning mechanism includes a cleaning assembly and a pulley system. The cleaning assembly includes a rack coupled to an inner shower surface, a roller comprising a gear configured to traverse along the rack, a cable configured to drive the gear from a first end of the rack towards a second end of the rack, a cleaner apparatus configured to wipe the inner shower surface, wherein an end of the apparatus is coupled to the roller, and a pulley system in communication with the cable.

At least one aspect of the present disclosure relates to a shower assembly. The faucet includes a shower door, a shower panel, a cleaning mechanism, and a pulley system in communication with the cable. The cleaning mechanism includes a rack coupled to an inner shower surface, a roller comprising a gear configured to traverse along the rack, a cable configured to drive the gear from a first end of the rack towards a second end of the rack, and a cleaner apparatus configured to wipe the inner shower surface, wherein an end of the apparatus is coupled to the roller.

At least one aspect of the present disclosure relates to a method. The method includes providing a cleaning mechanism for a shower assembly including a first cleaning assembly disposed at a top of an inner surface of a shower door comprising a first rack coupled to the inner surface of the shower door, a first roller comprising a first gear, a first cable, a first apparatus, wherein an end of the first apparatus is coupled to the first roller and including a second cleaning assembly disposed at a top of an inner surface of a shower panel comprising a second rack coupled to the inner surface of the shower panel, a second roller comprising a second gear, a second cable, and a second apparatus, wherein an end of the second apparatus is coupled to the second roller. The method includes opening the shower door such that the first roller moves along the first rack, the first apparatus wipes the inner surface of the shower door, the second roller moves along the second rack, and the second apparatus wipes the inner surface of the shower panel.

### BRIEF DESCRIPTION OF THE DRAWINGS

FIG. 1 is a front view of a traditional shower assembly, according to an exemplary embodiment.

FIG. 2 is a perspective view of a shower enclosure assembly, according to an exemplary embodiment.

FIG. 3 is a front perspective view of a cleaning mechanism of the shower enclosure assembly of FIG. 1, according to an exemplary embodiment.

FIG. 4 is a top perspective view of the cleaning mechanism of FIG. 3, according to an exemplary embodiment.

FIGS. 5A-5D show perspective views of the cleaning mechanism of FIG. 3 in various stages, according to an exemplary embodiment.

FIG. 6 shows a buffer assembly of the cleaning mechanism of FIG. 3, according to an exemplary embodiment.

### DETAILED DESCRIPTION

Generally, handles of faucets facilitate allowing a user to control a flow rate of fluid, a temperature of fluid, or various other aspects of fluid flowing through the faucet. In instances in which a handle, or a portion of a handle, needs to be removed or replaced, the removal process often requires the faucet to be deconstructed or completely disassembled from a mounting structure supporting the faucet (e.g., from a countertop or other surface). Such deconstruction of the faucet can be time consuming and may result in damage to one or more portions of the faucet. Accordingly, a handle assembly that facilitates allowing for easy removal and/or replacement of one or more portions of the handle with minimal reconstruction to the faucet may be desired.

Referring generally to the FIGURES, disclosed herein is a handle assembly for a faucet that can be installed in an environment (e.g., bathroom, shower, kitchen, etc.). The handle assembly includes at least one handle (e.g., lever arm) that a user can grasp to control various functions of the faucet. The handle assembly includes various components that facilitate fixing the handle with a base of the faucet. At least a portion of the handle assembly can be partially disassembled while at least a portion of the base of the faucet remains installed in the environment. For example, the handle lever arm of the handle assembly can be removed from the base of the faucet and replaced with a different handle lever arm while at least a portion of the faucet remains installed with the environment. Thus, the handle assembly may allow for the handle of the faucet to be accessed, replaced, or otherwise removed with minimal reconstruction to the faucet or faucet base as compared to conventional techniques.

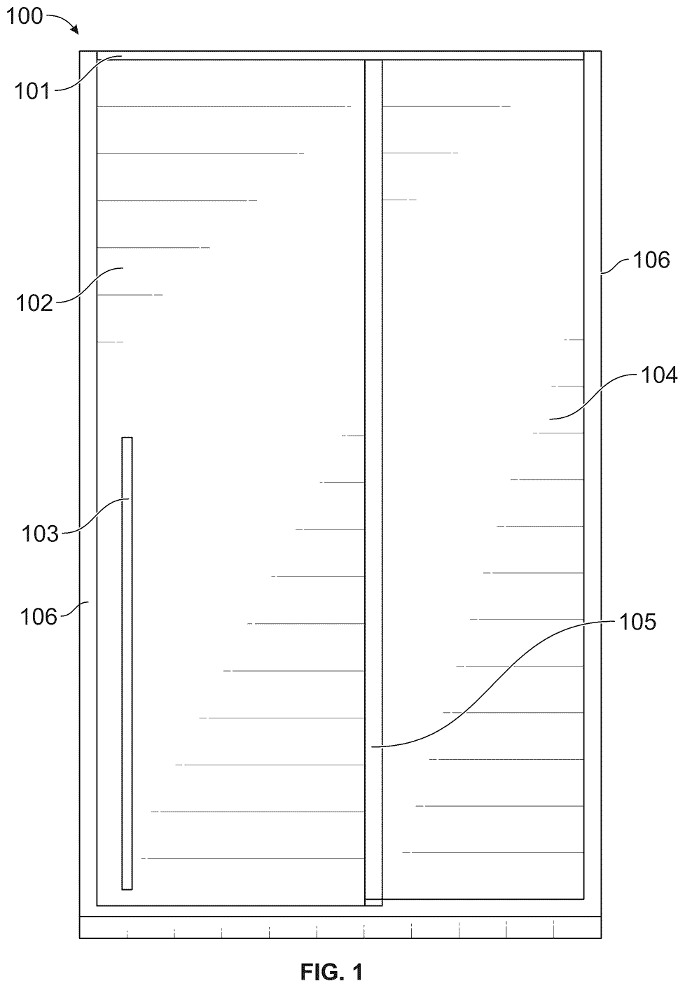

FIG. 1 depicts a perspective view of a traditional shower enclosure 100, shown as shower enclosure 100, according to an example embodiment. The shower enclosure 100 includes a glass panel 104 and a glass door 102, which are connected by means of a hinged frame 105. The shower enclosure 100 further includes a top frame 101 and side frames 106, which enable the shower enclosure 100 to be affixed to an existing structure such as a wall or other similar structure in a shower area. The glass door 102 may be opened by means of a handle 103 located on the surface of the glass door 102.

Traditional systems, such as the shower enclosure 100, rely on manual actions (e.g., by a user) for cleaning the glass door 102 and/or the glass panel 104, such as a part of routine maintenance.

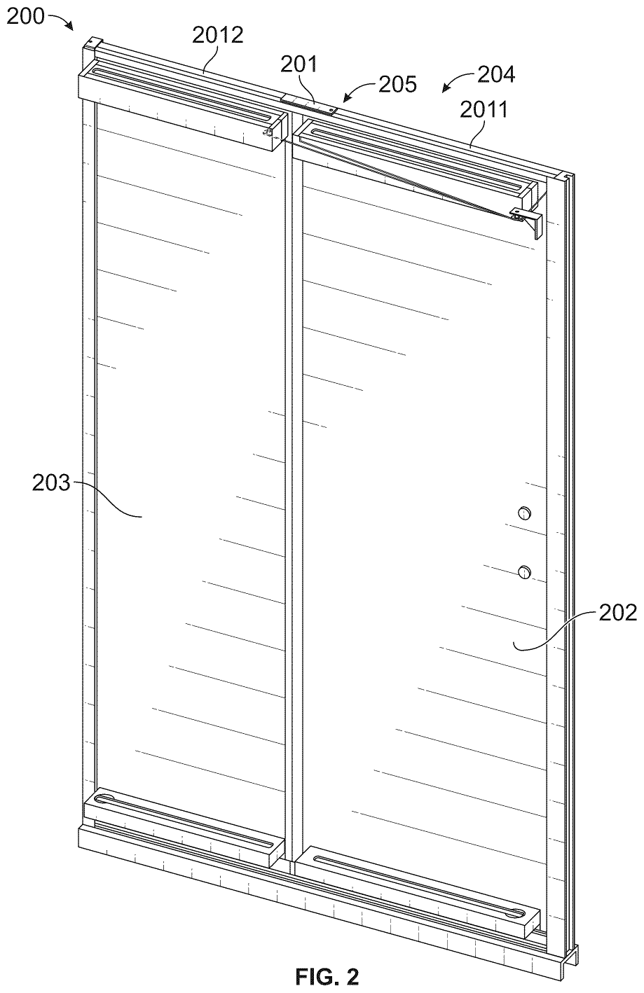

FIG. 2 depicts a perspective view of a shower assembly 200, according to an example embodiment of the present disclosure. The shower assembly 200 includes a cleaning mechanism 204 integrated at a top frame 201. The cleaning mechanism 204 includes a cleaning assembly 205. The cleaning assembly includes at least a two-part structure including a first cleaning assembly 2011 and a second cleaning assembly 2012. In some implementations, the first cleaning assembly 2011 is associated with a door (e.g., a glass door), shown as door 202, and the second cleaning assembly 2012 is associated with a panel (e.g., a glass panel), shown as panel 203. Each of the first cleaning assembly 2011 and the second cleaning assembly 2012 may further include a cleaner apparatus 206, such as one or both of a wiper and a buffer assembly, as well as a pulley, a cable, and gear assembly.

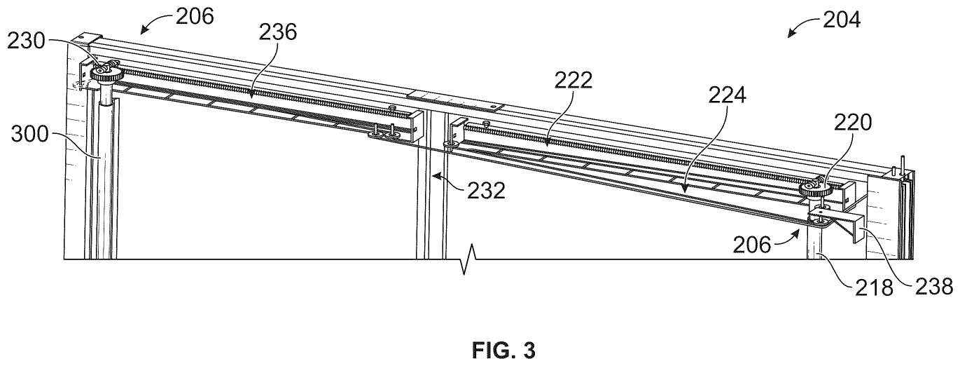

FIG. 3 depicts a perspective view of the cleaning mechanism 204 of the shower assembly 200, according to an example embodiment. The first cleaning assembly 2011 is disposed on the top frame 201 of the door 202 includes a first wiper 218 for wiping the door 202. The first wiper 218 may be a shaft (e.g., a vertical idler shaft) connected to an inner side/edge of the door 202 (e.g., an inner side facing a user when the user is inside the shower assembly 200). The length, diameter and other dimensions of the first wiper 218 are customizable and are not intended to be limiting factor of the cleaning mechanism 204 and/or the shower assembly 200, in accordance with the principles of the present disclosure. In some implementations, a buffer assembly 300 may be used in place of wiper 218, wherein the buffer assembly 300 rotates along the axis of the idler shaft and also moves in a wiping movement along the glass surface.

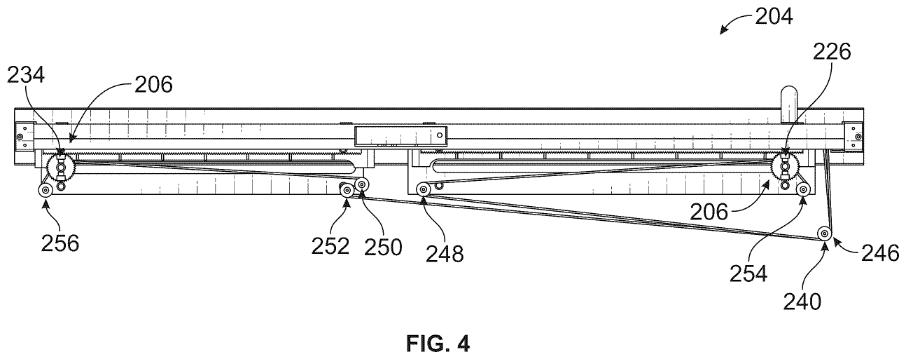

Referring to FIGS. 3-4, depicts an end of the first wiper 218 is connected to a first horizontal roller 220, at the top frame 201 of the door 202. The first horizontal roller 220 is configured to traverse upon (e.g., move along) a first rack 222, such as in a rack and pinion relationship. In some implementations, the horizontal roller 220 may be connected to an idler shaft on the buffer assembly 300. A first cable 224 is configured to drive a first gear 226 on the first rack 222. The first rack 222 and/or the first gear 226 may be attached to the door 202.

Similarly, the second cleaning assembly 2012 is disposed at the top of panel 203 and includes a second wiper or buffer, shown as buffer assembly 300, a second horizontal roller 230, a second cable 232, a second gear 234, and a second rack 236. A similar gear assembly (e.g., a rack and pinion arrangement, a gear and a rack assembly) is provided for at the bottom surface of the door 202 and the panel 203.

Referring still to FIGS. 3-4, the cleaning mechanism 204 includes a pulley system. In some cases, a first pulley 240 is fixed to frame 238 with a first cable 242 running over it. The fixed frame/bracket is to be mounted on the wall. A second pulley 246 is positioned parallelly to the first pulley 240. The first and the second pulleys 240, 246 are located at the inner side of the door 202. A third pulley 248 is fixed on the door, located distally from the pulleys 240, 246. The first cable 242 extends from idler shaft of gear 226, passes over pulley 248, then over pulley 240 and terminates at the corner of the door 202.

A second set of pulleys, i.e., a fourth and fifth pulley 250, 252 are positioned on the panel 203, located distally from the second wiper (buffer assembly 300). The second cable 232 is positioned on the second set of pulleys 250, 252 for driving the gear second gear 234 located on the rack second rack 236 associated with the panel 203. The second cable 232 extends from extends from idler shaft of second gear 234, passes over the pulleys 250, 252, then over the second pulley 246 and terminates at the corner of the door 202.

At the assembly part located in the door 202, a first retractable pulley 254 is provided which exerts retractable force on gear (first gear 226) to enable it to be restored to its original position after a cleaning cycle. Similarly, a second Retractable Pulley 256 is provided at the assembly part on the panel 203, which exerts retractable force on Gear (first gear 226) to enable it to be restored to its original position after a cleaning cycle.

The configuration, placement and orientation of the door 202, the panel 203, pulleys 240, 246, 248, 250, 252, 252, 254, gear assembly (first gear 226 and first rack 222, second gear 234 and second rack 236) and the rollers 220, 230 with reference to the top and bottom surface disclosed via FIGS. 1-4 are depiction of a preferred embodiment of the present invention. Alternative or varied configurations, placements, and/or orientations of the components, without departing from the principles and scope of the present disclosure, may be implemented within the shower assembly 200.

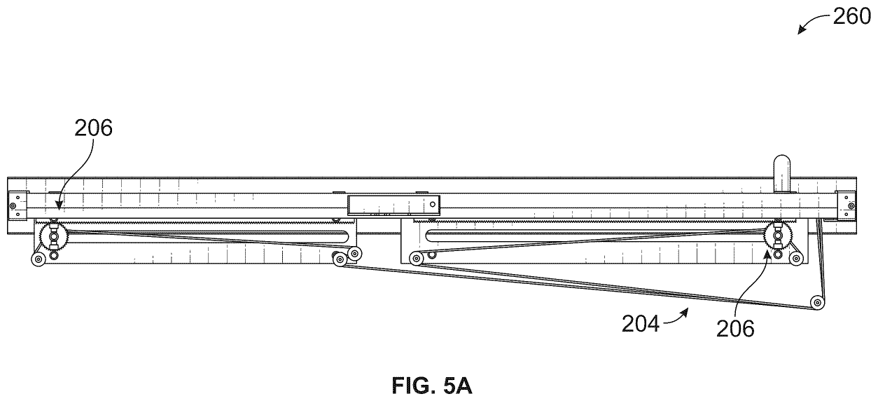

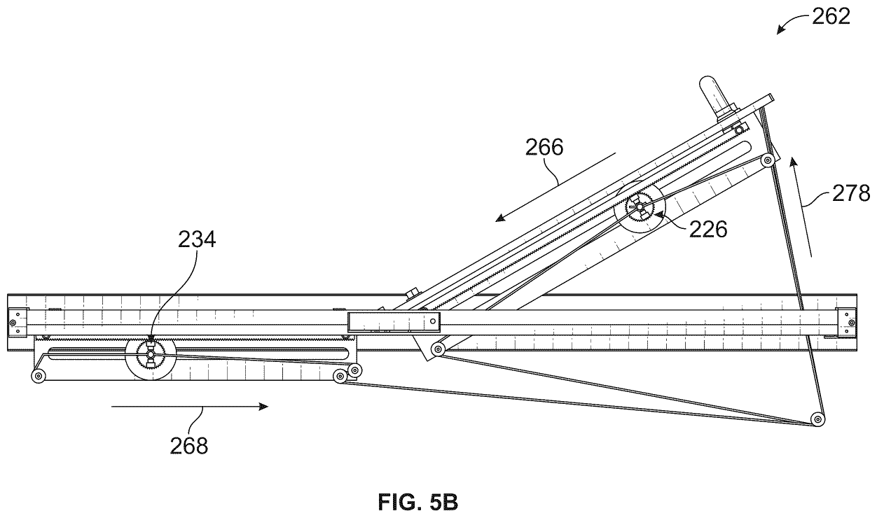

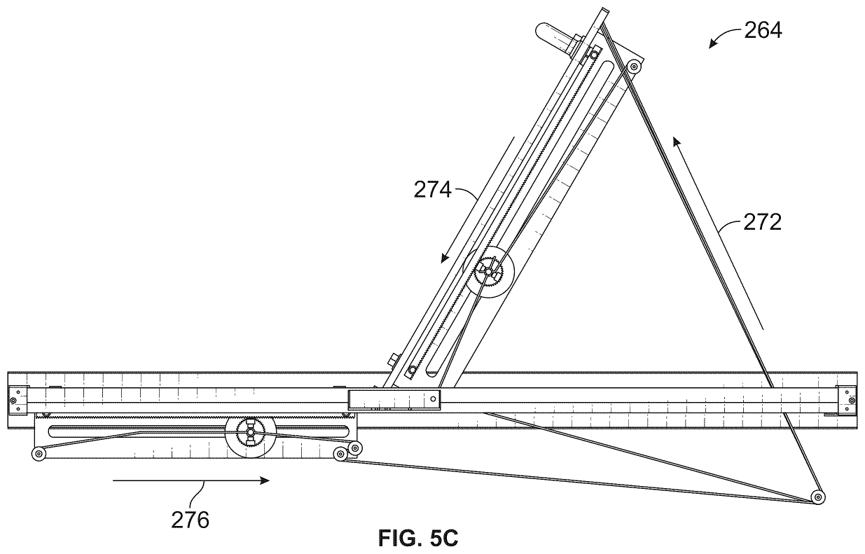

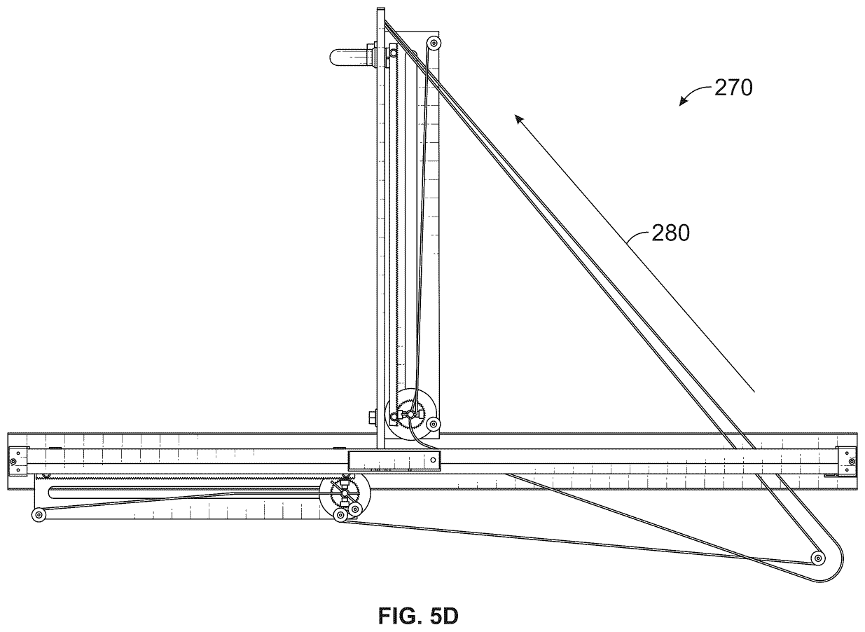

FIGS. 5A-5D show the cleaning mechanism 204 of the shower assembly 200 in various stages. Referring to FIG. 5A, the shower assembly 200 is shown in a door closed state 260. At this state, the gears 226, 234 are positioned at their respective extreme ends on the panel 203 and the door 202. Each of the idler shafts of gears 226, 234 are connected to two cables. In some cases, the idler shaft of first gear 226 is connected with the first cable 224 and another cable from the first retractable pulley 254 and the idler shaft of the second gear 234 is connected with the second cable 232 and another cable from the second retractable pulley 256.

The first cable 224 is attached to an idler shaft of first gear 226 and is connected to the innermost end of the door by passing over the pulleys 248, 240, as highlighted through door closed state 260.

The second cable 232 is attached to an idler shaft of the second gear 234 and is connected to the inner side of the door 202 by passing over the pulleys 250, 252, 246, as highlighted through state door closed state 260.

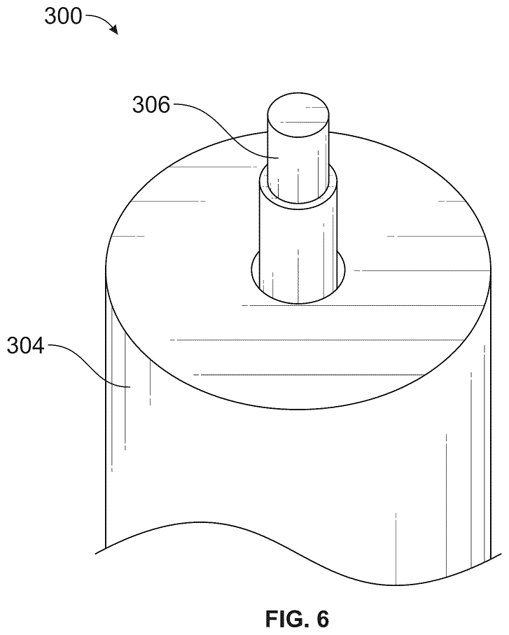

The rollers 220, 230 are mounted on idler shaft of gears 226, 234, which aid in carrying the weight and linear motion of buffer assemblies 300. As visualized in FIG. 6, the buffer sub-assemblies 300 consist of a buffer head 304 mounted on a hollow shaft. The hollow shaft is meant to rotate over a fixed shaft 306 with the aid of bearing. The fixed shaft 306 is in turn attached to the rotating gears (pinion). In a preferred embodiment, the buffer head 304 is made up of a soft material such as cotton shreds.

FIG. 5B identifies the shower enclosure 100 in a first door opened state 262, in which the door is opened at (about) 30 degrees.

As the door 202 is opened, the cables (first cable 224, second cable 232), attached to the top frame 201, are tensioned in a manner such that door opening distance is equal to length of cable pulled. This is highlighted by the door opened state 262 and the pinion gear (first gear 226) movement direction (second door opened state 264).

As the cables (first cable 224, second cable 232) are pulled, they cause the idler shafts of pinion gears (first gear 226, second gear 234) to traverse along the length of racks (first rack 222, second rack 236). Thus, the pinion gears (first gear 226, second gear 234) move from their resting position to a position on the racks (first rack 222, second rack 236), as identified by their states (movement direction 266, movement direction 268) and slide along the door 202 and panel 203 respectively. Consequently, the long shafts with wiper heads (first wiper 218, buffer assembly 300) are moved along the door 202 and the panel 203 respectively, in a wiping motion along the respective surface. In another embodiment, the long shafts with buffer assemblies 300 are moved along the door 202 and the panel 203 respectively, in addition to the rotational movement of the buffer assembly 300.

FIG. 5C identifies the shower enclosure 100 in a second door opened state 264, in which the door is opened at (about) 60 degrees.

The motion of the pinion gears (first gear 226, second gear 234) and its corresponding pull on the cables (first cable 224, second cable 232), i.e., identified by movement directions (movement direction 272, movement direction 274, movement direction 276) causing wiping motion along the surfaces of the door 202 and the panel 203 are identical to that of the states (movement direction 278, movement direction 266, movement direction 268) described above.

In this state (state 264), the pinion gears (first gear 226, second gear 234) travel along the racks (first rack 222, second rack 236) and approach the other end, while simultaneously causing movement of the wipers or buffers (first wiper 218, buffer assembly 300) on its respective surface.

FIG. 5D identifies the shower enclosure 100 in a third door opened state 270, in which the door is opened at (about) 90 degrees.

In this state (state 270), the pinion gears (first gear 226, second gear 234) completely traverse along the racks (first rack 222, second rack 236) thereby completing the wiping action of the door 202 and the panel 203, shown as movement direction 280.

While the door is being closed, i.e., movement of the door 202 from 90 degrees to 0 degrees, the door moves in an opposite direction causing the pinion gears (first gear 226, second gear 234), under the influence of retractable force, to move towards its original position. Thereby, a buffing action is caused on the door 202 and the panel 203 in an opposite direction as well.

The above mechanism discloses a complete cleaning cycle of a preferred embodiment of a shower enclosure 200 in a forward and backward motion, without expending any additional manual force, but instead relying only upon the door opening and closing motion.

Although, particular embodiments have been disclosed herein in detail, this is for illustrative purposes only and is not intended in any way to limit the intended scope of the invention. Variations and adaptions of the system as described herein do not depart from the spirit and scope of the invention and is within the expertise of a person skilled in the art.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The terms “coupled,” “connected,” and the like, as used herein, mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Such references used in conjunction with “comprising” or other open terminology can include additional items.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the shower assembly and/or cleaning mechanism as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements, the position of elements may be reversed or otherwise varied, and the nature or number of discrete elements or positions may be altered or varied.

Additionally, the word “exemplary” is used to mean serving as an example, instance, or illustration. Any embodiment or design described herein as “exemplary” is not necessarily to be construed as preferred or advantageous over other embodiments or designs (and such term is not intended to connote that such embodiments are necessarily extraordinary or superlative examples). Rather, use of the word “exemplary” is intended to present concepts in a concrete manner. Accordingly, all such modifications are intended to be included within the scope of the present disclosure. Other substitutions, modifications, changes, and omissions may be made in the design, operating conditions, and arrangement of the preferred and other exemplary embodiments without departing from the scope of the appended claims.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Other substitutions, modifications, changes and omissions may also be made in the design, operating conditions and arrangement of the various exemplary embodiments without departing from the scope of the present invention. For example, any element disclosed in one embodiment may be incorporated or utilized with any other embodiment disclosed herein. Also, for example, the order or sequence of any process or method steps may be varied or re-sequenced according to alternative embodiments. Any means-plus-function clause is intended to cover the structures described herein as performing the recited function and not only structural equivalents but also equivalent structures. Other substitutions, modifications, changes and omissions may be made in the design, operating configuration, and arrangement of the preferred and other exemplary embodiments without departing from the scope of the appended claims.

What is claimed is:

1. A cleaning mechanism for a shower assembly, comprising:
a cleaning assembly comprising:
a rack coupled to an inner shower surface;
a roller comprising a gear configured to traverse along the rack;
a cable configured to drive the gear from a first end of the rack towards a second end of the rack; and
a cleaner apparatus configured to wipe the inner shower surface, wherein the cleaner apparatus is coupled to the roller; and
a pulley system in communication with the cable.

2. The cleaning mechanism of claim 1, wherein the cleaning assembly is a first cleaning assembly configured to be disposed at a top of a shower door, further comprising a second cleaning assembly configured to be disposed at a top of a shower panel, the shower panel adjacent to the shower door.

3. The cleaning mechanism of claim 1, wherein the cleaner apparatus is one of a wiper assembly or a buffer assembly.

4. The cleaning mechanism of claim 3, wherein the buffer assembly comprises:
a fixed shaft, wherein an end of the fixed shaft is coupled to the gear;
a hollow shaft rotably surrounding the fixed shaft; and
a buffer head surrounding the hollow shaft.

5. The cleaning mechanism of claim 2, wherein the second cleaning assembly comprises:
a second rack coupled to an inner surface of the shower panel;
a second roller comprising a second gear configured to traverse along the second rack;
a second cable configured to drive the second gear from a first end of the second rack towards a second end of the second rack; and
a second apparatus configured to wipe the inner surface of the shower panel, wherein an end of the second apparatus is coupled to the second roller.

6. The cleaning mechanism of claim 5, wherein the pulley system comprises:
a first pulley coupled to a frame positioned at a lateral edge of the shower door;
a second pulley positioned parallelly to the first pulley; and
a third pulley coupled to an internal surface of the shower door positioned between the first and second pulleys and the shower panel.

7. The cleaning mechanism of claim 6, wherein the frame is mounted to a wall.

8. The cleaning mechanism of claim 6, wherein the cable extends from the gear around the first pulley and the third pulley to the lateral edge of the shower door.

9. The cleaning mechanism of claim 8, wherein the pulley system further comprises:
a fourth pulley and a fifth pulley positioned at a first edge of the shower panel.

10. The cleaning mechanism of claim 9, wherein the second cable extends from the second gear around the fourth pulley, the fifth pulley, and the second pulley to the lateral edge of the shower door.

11. The cleaning mechanism of claim 10, wherein the pulley system further comprises:
a first retractable pulley coupled to the gear via a first wire configured to drive the gear towards the first end of the rack; and
a second retractable pulley coupled to the second gear via a second wire configured to drive the second gear towards the first end of the second rack.

12. A shower assembly, comprising:
a shower door;
a shower panel;
a cleaning mechanism comprising:
a rack coupled to an inner shower surface;
a roller comprising a gear configured to traverse along the rack;
a cable configured to drive the gear from a first end of the rack towards a second end of the rack; and
a cleaner apparatus configured to wipe the inner shower surface, wherein the cleaner apparatus is coupled to the roller; and
a pulley system in communication with the cable.

13. The shower assembly of claim 12, wherein the cleaning assembly is a first cleaning assembly disposed at a top of the shower door, further comprising a second cleaning assembly disposed at a top of the shower panel, the shower panel adjacent to the shower door.

14. The shower assembly of claim 13, wherein the second cleaning assembly comprises:
a second rack coupled to an inner surface of the shower panel;
a second roller comprising a second gear configured to traverse along the second rack;
a second cable configured to drive the second gear from a first end of the second rack towards a second end of the second rack; and
a second apparatus configured to wipe the inner surface of the shower panel, wherein an end of the second apparatus is coupled to the second roller.

15. The shower assembly of claim 14, wherein the pulley system comprises:
a first pulley coupled to a frame positioned at a lateral edge of the shower door;
a second pulley positioned parallelly to the first pulley;
a third pulley coupled to an internal surface of the shower door positioned between the first and second pulleys and the shower panel; and
a fourth pulley and a fifth pulley positioned at a first edge of the shower panel, wherein
the cable extends from the gear around the first pulley and the third pulley to a lateral edge of the shower door, and
the second cable extends from the second gear around the fourth pulley, the fifth pulley, and the second pulley to the lateral edge of the shower door.

16. The shower assembly of claim 15, wherein the pulley system further comprises:
a first retractable pulley coupled to the gear via a first wire configured to drive the gear towards the first end of the rack; and
a second retractable pulley coupled to the second gear via a second wire configured to drive the second gear towards the first end of the second rack.

17. A method, comprising:
providing a cleaning mechanism for a shower assembly, the cleaning mechanism including:
a first cleaning assembly disposed at a top of an inner surface of a shower door comprising:
a first rack coupled to the inner surface of the shower door;
a first roller comprising a first gear;
a first cable; and
a first apparatus, wherein an end of the first apparatus is coupled to the first roller; and
a second cleaning assembly disposed at a top of an inner surface of a shower panel comprising:
a second rack coupled to the inner surface of the shower panel;
a second roller comprising a second gear;
a second cable; and
a second apparatus, wherein an end of the second apparatus is coupled to the second roller; and
opening the shower door such that the first roller moves along the first rack, the first apparatus wipes the inner surface of the shower door, the second roller moves along the second rack, and the second apparatus wipes the inner surface of the shower panel.

18. The method of claim 17, wherein opening the shower door further comprises engaging the first cable to move the first gear in a first direction and engaging the second cable to move the second gear in a second direction.

19. The method of claim 18, further comprising:
closing the shower door such that the first roller moves along the first rack in a third direction opposite the first direction and the second roller moves along the second rack in a fourth direction opposite the second direction.

20. The method of claim 19, wherein closing the shower door further comprises engaging a first retractable cable to move the first gear in the third direction and engaging a second retractable cable to move the second gear in the fourth direction.
